(19) United States
(12) Patent Application Publication
(10) Pub. No.: US 2009/0151525 A1
(43) Pub. Date: Jun. 18, 2009

(54) Blades coated with a nickel boron metal coating

(76) Inventor: McComas Ed, Palm City, FL (US)

Correspondence Address: SAM SILVERBERG, 6820 32nd St. NW, Washington, DC, 20015, US

(21) Appl. No.: 12/000,537

(22) Filed: Dec. 13, 2007

(51) Int. Cl. B26D 7/08; B32B 15/04; B26D 1/00

(52) U.S. Cl. 83/170; 428/457; 83/13

(57) ABSTRACT

The saw and cutting blades of this invention have an electroless nickel boron coating applied from a bath containing metal stabilizers. The metal stabilizer is usually introduced into the coating from an electroless coating bath and is co-deposited into the coating. The source of the metal stabilizer is usually a metal compound or salt that is used to stabilize the nickel boron bath.

### FIELD OF INVENTION

This invention relates to an electroless nickel boron metal coated blades for cutting, or slicing or sawing, or slitting various material. This invention is applicable to any type of saw blade, slitter blade, shear blade or knife where heat is generated between the materials being cut, sliced, and/or severed into two or more pieces and the cutting, sawing, severing, slicing device.

### BACKGROUND OF THE INVENTION

Cutting material with a saw blade or cutting blade generates heat between the material and the blade. The heat can cause damage to the material such as wood or plastic by means of oxidation/burning at the “cut edge” and/or cause damage to the saw blade by distorting its normally flat plane eg; warping. To reduce the heat and oxidation the speed or feed rate at which material is fed into the saw is normally limited. This reduces the overall throughput or amount of material that can be sawed over a given time. When excessive heat does occur, distortion such as warping and other damage to the saw blade or cutting blade results. This requires the blade to be reconditioned or replaced on a regular basis.

The prior art has recognized a need for a cooler functioning blade. The prior art describes many methods of cooling various saw blades, such as water cladding and cryogenic gases. Also blade designs that generate less heat and/or dissipating heat more efficiently have been used.

The prior art teaches the use of both organic and inorganic coatings such as hard chrome and Teflon. Teflon coatings provide a reduction of friction but do not have the desired wear and abrasion resistance. Type-2 nickel boron as described below has been used on blades to provide wear resistance and a reduction in operating temperature. However a further reduction in blade temperature is highly desirable as these blades are temperature sensitive, which can cause them to distort at temperatures as low as 150° F. In addition, every reduction in operating temperature degrees allows the operator the option of increasing throughput without damaging blades or oxidizing the product.

### BRIEF DESCRIPTION OF THE DRAWINGS

FIG. 1 shows a comparison of thermal values for Type-1 and Type-2 and Type-3 coated circular saw blades.

FIG. 2 shows a comparison of thermal values for Type-1 and Type-2 and Type-3 coated reciprocating saw blades.

### DETAILED DESCRIPTION OF THE INVENTION

The saw and cutting blades of this invention have an electroless nickel boron coating applied from a bath containing metal stabilizers. The metal stabilizer is usually introduced into the coating from an electroless coating bath and is co-deposited into the coating. The source of the metal stabilizer is usually a metal compound or salt that is used to stabilize the nickel boron bath. The amount of the metal stabilizer in the coating is about 1% to about 5% wgt of the coating. The coating composition can range from; 1-5% metal stabilizer, 1-5% boron and the remainder nickel. The co-deposited metal stabilizer is considered to form a poly-alloy deposit of nickel, boron with the metal stabilizer element. Metals salts such as thallium sulfate or lead chloride can be used. These metals have been used in the prior art to stabilize electroless alkaline nickel boron baths. The resulting poly alloy coatings have inferior properties such as wear resistance and hardness in comparison to Type-2, and Type-3 nickel boron. Although these coatings have less wear resistance and hardness properties it has been found that these poly alloy nickel boron coatings provide unexpected benefits when used to coat a saw blade. Type-1 coatings not only provide the requisite wear and abrasion resistance they have the additional property of decreasing distortions such as warping of the saw blade by dissipating or reducing heat more efficiently.

There are three types of alkaline electroless nickel boron coatings. The Type-1 is taught in U.S. Pat. No. 3,674,447 to Bellis filed Jul. 4, 1972, which is incorporated by reference. Metal elements such as thallium and lead are used to stabilize the electroless plating. These metal elements form a poly alloy with the nickel boron coating. A typical Type-1 electroless coating has about 1-3% thallium, 2-4% boron and 97-92% nickel by weight.

The Type-2 is taught in U.S. Pat. No. 6,066,406 to McComas which is incorporated by reference. A typical Type-2 electroless coating has 1-6% boron, 99-94% nickel,

The Type-3 is taught in U.S. patent application Ser. No. 10/903,687 filed Aug. 2, 2004 entitled Electroless Coating with Nanometer Particles to Ed McComas. A typical Type-3 electroless coating has Nickel Boron plus nanometer DLC particles. 1-6% boron, 99-94% nickel plus co-deposition of solid DSLC particles.

### Experiments

To eliminate design variables; identical 7-inch diameter blades made by Oldham Inc were used to compare all coatings. All blades were plated all over except for the arbor hole. All blades during this phase of testing were plated 0.0005-0.0007 thick.

1. One set of Oldham, 7-inch, combination-cut, circular saw blades were coated with Type-1 poly alloy nickel boron thallium having a thickness of 0005-0.0007 inch thick according to U.S. Pat. No. 3,674,447 filed on—to Bellis. Witness panels were coated along with the blades, the knoop hardness of the coating averaged 780-810 Hk when tested with a 25 gr load. And after heat treatment at 725° F. for 90 minutes, the knoop, hardness was 950-1020 Hk, when tested with a 25 gr load. Surface roughness averaged 2.71 Ra. A cross-section view of the coating exhibited the highest level of porosity as compared to Type-2 and Type-3 and with a large distinction between columnar grain boundaries contributing to the lowest cohesive/shears strength of the three types.
2. A second set of Oldham 7-inch blades, identical to set one above were coated with Type-2, nickel boron coating to a thickness of 0.0005-0.0007. Average knoop hardness ranged from 910-1000 Hk tested with a 25 gr load. After heat treatment at 725° F. for 90 minutes, the knoop hardness was 1310-1360 Hk when tested with a 25 gram load. Porosity was improved over Type-1. Surface roughness was improved over type-1 averaging 1.71 Ra.
3. A third set of identical 7-inch blades were coated with Type-3 nickel boron coating. The average knoop hardness ranged between 1050 Hk-1110 Hk with a 25 gram load. After heat treatment at 725° F. for 90 minutes the knoop hardness was 1550 Kh-1570 Hk when tested with a 25-gr load. Porosity was nil and after heat treatment, the obvious columnar boundaries noted in both Type 1 & 2 were not visible. Cohesive strength was significantly greater with a marked increase in cubic density. Surface roughness averaged 1.29 Ra and was smoother to the touch. After coatings were applied but prior to testing, the surface finish or roughness of each coated blade was measured using a proflometer and the value recorded using Ra metric scale. Each blade's roughness was measured at 3 random locations on the outer ⅓ of the blade diameter and averaged together

To determine a reduction in operating temperature, the thermal values from each blade was monitored under increasing load intervals as the blades rotated at 1750 RPM. While the blade was rotating a piece of white pine, having dimensions 1″×1″×6-inch, was pressed at various loads against the rotating saw blade body at a 90* angle for a duration of 4 minutes. Temperature measurements were obtained using a Fluke, Model-63 Infrared Thermometer while increasing loads were applied. The highest value locked into the thermometer was recorded as final value at each load level.

Nickel Boron Comparison; as plated condition vs polished to a lower surface finish.
Type-1, nickel, boron and thallium as plated 2.71-Ra
@ 0 lbs, 91° F.
@ 10 lbs, 4 minutes duration; 98° F.
@ 20 lbs, 4 minutes duration, 102° F.
@ 25 lbs, 4 minutes duration, 127° F.
@ 30 lbs, 4 minutes duration 136° F.
Type-1 Vibratory finished using Mikronite process; 0.52-Ra
@ 0 lbs, 91° F.
@ 10 lbs, 4 minutes duration; 97° F.
@ 20 lbs, 4 minutes duration, 106° F.
@ 25 lbs, 4 minutes duration, 133° F.
@ 30 lbs, 4 minutes duration 137° F.
Type-2, Nickel and Boron as plated, 1.71-Ra
@ 0 lbs, 91° F.
@ 10 lbs, 4 minutes duration; 102° F.
@ 20 lbs, 4 minutes duration, 112° F.
@ 25 lbs, 4 minutes duration, 157° F.
Type-2 Vibratory finished using Mikronite process; 0.42-Ra
@ 0 lbs, 91° F.
@10 lbs, 4 minutes duration; 106° F.
@ 20 lbs, 4 minutes duration, 132° F.
@ 25 lbs, 4 minutes duration, 147° F.
@ 30 lbs, 4 minutes duration 188° F.
Type-3 Nickel Boron plus DLC as plated 1.29 Ra
@ 0 lbs, 91° F.
@ 10 lbs, 4 minutes duration; 107° F.
@ 20 lbs, 4 minutes duration, 122° F.
@ 25 lbs, 4 minutes duration, 157° F.
@ 30 lbs, 4 minutes duration 178° F.
Type-3 Vibratory finished using Mikronite process; 0.46 Ra
@ 0 lbs, 91° F.
@10 lbs, 4 minutes duration; 106° F.
@ 20 lbs, 4 minutes duration, 128° F.
@ 25 lbs, 4 minutes duration, 171° F.
@ 30 lbs, 4 minutes duration 198° F.

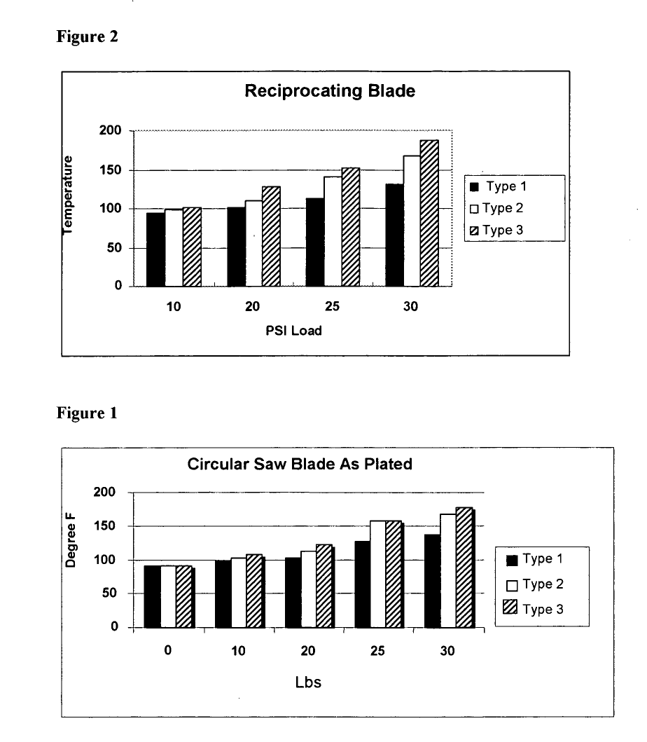

After coatings were applied but prior to testing, the surface finish or roughness of each coated blade was measured using a proflometer and the value recorded using Ra metric scale. Each blade's roughness was measured at 3 random locations on the outer ⅓ of the blade diameter and averaged together. The results show that Type-1 electroless nickel boron coatings to be superior to Type 2 and Type 3 in heat dissipation even though type-1 had the highest roughness. The results are displayed in FIG. 1

### Test Method, Reciprocating Saw Blade.

To confirm the results from the Circular Saw Blades, a second test was performed using a reciprocating saw made by Milwaukee Saw, model; Sawzall Brand.

One test was performed using coated blades in there “as plated condition” meaning without any post polishing processes. A second identical test to the first was performed using coated saw blades that were polished prior to testing. To ensure polishing was consistent, mass vibratory polishing was used.

The test was performed as follows. A reciprocating saw motor, Milwaukee SawzAll brand was fixed to a table by fabricating a solid bracket. The motor was positioned so that the blades could move unobstructed back and forth. Two ¾-inch diameter by 3 inches long oak dowel rods were bolted through there centers to the same table in front of the saw motor, inline with the 8-inch long blades so that both dowel rods, spaced about 4 inches apart, would have contact with one side of the blade as it traveled back and forth. To apply rubbing load, a third ¾ inch dowel rod was placed on the opposite side of the two 1-inch dowel rods at a right angle to the blade held by a fixed 1-inch steel pipe about 5 inches long so the ¾ inch dowel could move back and forth inside the fixed steel pipe, placed horizontally, so that contact would be between the two supporting dowels on the opposite side. One end of the dowel rod contacted the moving saw blade while the other end was loaded by a hydraulic ram head.

As the saw blade traveled back and forth, the hydraulic ram excreted pressure on one end of the ¾-inch dowel rod which applied pressure to the opposite end of the rod making contact with the moving saw blade that was supported by the 1-inch dowel rods on the opposite side of the blade. This had the effect of “sandwiching” the moving blade between the stationary wooden dowel rods.

Temperature measurements were obtained using a Fluke, Model-63 Infrared Thermometer while increasing loads were applied. The highest value locked into the thermometer was recorded as final value at each load level. The results show that Type-1 electroless nickel coatings to be superior to Type 2 and 3 in heat dissipation.

The test results were as follows:
Type-1 as plated 2.71-Ra
@10 lbs, 4 minutes duration; 94° F.
@ 20 lbs, 4 minutes duration, 102° F.
@ 25 lbs, 4 minutes duration, 112° F.
@ 30 lbs, 4 minutes duration 131° F.
Type-1 Vibratory finished using Mikronite process; 0.52-Ra
@ 10 lbs, 4 minutes duration; 94° F.
@ 20 lbs, 4 minutes duration, 101° F.
@ 25 lbs, 4 minutes duration, 120° F.
@ 30 lbs, 4 minutes duration 134° F.
Type-2 as plated, 1.71-Ra
@10 lbs, 4 minutes duration; 98° F.
@ 20 lbs, 4 minutes duration, 110° F.
@ 25 lbs, 4 minutes duration, 141° F.
@ 30 lbs, 4 minutes duration 168° F.
Type-2 Vibratory finished using Mikronite process; 0.42-Ra
@ 10 lbs, 4 minutes duration; 103° F.
@ 20 lbs, 4 minutes duration, 129° F.
@ 25 lbs, 4 minutes duration, 143° F.
@ 30 lbs, 4 minutes duration 172° F.
Type-3 as plated 1.29 Ra
@ 10 lbs, 4 minutes duration; 101° F.
@ 20 lbs, 4 minutes duration, 128° F.
@ 25 lbs, 4 minutes duration, 152° F.
@ 30 lbs, 4 minutes duration 188° F.
Type-3; Vibratory finished using Mikronite process; 0.46 Ra
@ 10 lbs, 4 minutes duration; 105° F.
@ 20 lbs, 4 minutes duration, 131° F.
@ 25 lbs, 4 minutes duration, 169° F.
@ 30 lbs, 4 minutes duration 198° F.

These results show that even though Type-1, Nickel, Boron and Thallium coatings had the lowest hardness, highest porosity, roughest surface finish and least shear strength, the lowest thermal values on both circular and reciprocating saw blade bodies were produced. FIG. 2 shows the results.

1. A blade comprising an electroless nickel boron metal Type 1 coating wherein the coating contains at least about 1% by weight elemental metal wherein the coating is formed by codepositing the elemental metal with the nickel and boron from an alkaline electroless bath and wherein the blade has a flat plane that warps or distorts when heated in excess of 150° F. during cutting without said coating.

2. A blade according to claim 1 wherein the metal is selected from the group consisting of lead and thallium.

3. A blade according to claim 1 wherein the coating comprises about 1-5% boron, about 1-5% thallium and about 90-98% nickel.

4. A blade according to claim 1 wherein the metal in the electroless nickel boron metal coating was used as stabilizer in elemental or compound form which co-deposits into the coating at an amount at least by about 1% by weight.

5. A blade according to claim 1 wherein the blade is selected from the group of cutting blades or saw blades.

6. A blade according to claim 2 wherein the blade is a saw blade.

7. A blade according to claim 3 wherein the blade is a saw blade.

8. A blade according to claim 2 wherein the blade is a slitter blade.

9. A blade according to claim 2 wherein the blade is selected from the group of cutting blades or saw blades.

10. A process of cutting material with a blade that is exposed to heat in excess of 120° F. during cutting comprising:
providing a motorized blade that has been coated with an electroless nickel boron metal coating, wherein the coating is formed by codepositing the elemental metal with nickel and boron from an alkaline electroless bath to form a type 1 coating, wherein the coating contains at least 1% by weight elemental metal, wherein the blade has a flat plane that warps or distorts when heated in excess of 150° F. during cutting without the coating, and cutting the material with the blade so that blade temperature is exposed to temperatures in excess of 120° F.

11. A process of cutting material with a blade according to claim 10 wherein the metal is selected from the group consisting of lead and thallium.

12. A process according to claim 11 wherein the coating comprises about 1-5% boron, about 1-5% thallium and about 90-98% nickel.

13. A process according to claim 10 wherein the metal in the electroless nickel boron metal coating was used as stabilizer in elemental or compound form which co-deposits into the coating at an amount at least by about 1% by weight.

14. A process according to claim 10 wherein the blade is selected from the group consisting of cutting blades, saw blades, or slitting blades and wherein the metal is not nickel.

15. A blade according to claim 1 wherein the metal is not nickel.

16. A process of cutting material with a blade according to claim 10 that is exposed to heat in excess or at 150° F.

17. A process of cutting material with a blade according to claim 10 wherein the blade is a saw blade.

18. A process of cutting material with a blade according to claim 17 wherein the material is wood.

19. A process of cutting material with a blade according to claim 10 where the metal is not nickel.

20. A blade according to claim 1 wherein the metal is not nickel.
